(19) United States
(12) Patent Application Publication
(10) Pub. No.: US 2004/0258968 A1
(43) Pub. Date: Dec. 23, 2004

(54) Cathode inlet gas humidification system and method for a fuel cell system

(76) Inventors: Mark G. Voss, Racine, WI (US); Joe Stevenson, Kenosha, WI (US); Liping Cao, Racine, WI (US); Alan P. Meissner, Franklin, WI (US)

Correspondence Address: WOOD, PHILLIPS, KATZ, CLARK & MORTIMER, 500 W. MADISON STREET, SUITE 3800, CHICAGO, IL, 60661, US

(21) Appl. No.: 10/393,688

(22) Filed: Mar. 21, 2003

(51) Int. Cl. H01M 8/04

(52) U.S. Cl. 429/26; 429/38; 429/13

(57) ABSTRACT

A method and system (10) are provided for humidifying a cathode inlet gas flow (18) in a fuel cell system (12) including a fuel cell (14) and a compressor (16) for supplying the cathode inlet gas flow (18) to a cathode side (20) of the fuel cell (14). According to the method and system (10) heat is transferred from the cathode inlet gas flow (18) to a cathode exhaust flow (24) at a first flow location with respect to the cathode inlet gas flow (18), and water vapor is transferred from the cathode exhaust flow (24) to the cathode inlet gas flow (18) at a downstream flow location from the first flow location with respect to the cathode inlet gas flow (18).

### FIELD OF THE INVENTION

This invention relates to systems and methods for humidifying the cathode inlet gas flow to the cathode side of a fuel cell.

### BACKGROUND OF THE INVENTION

The electrolyte membranes in solid electrolyte membrane type fuel cells, such as polymer electrolyte membrane fuel cells commonly referred to as proton exchange membrane (PEM) fuel cells, require a relatively high level of water saturation to protect the membranes from damage and the fuel cell from performance degradation. It is known to humidify the reactant flows, commonly referred to as the anode and cathode inlet gas flows, to provide a sufficient supply of water to maintain adequate water saturation of the electrolyte membrane. One conventional approach to humidify the reactant flows is to utilize a water reservoir and transport system. However, this approach requires additional equipment and can be subject to freezing during cold weather operation. One known source for at least part of the water for such an approach are the fuel cell exhaust flows, which carry water and heat generated by the electrochemical reactions in the fuel cell. Conventionally, one or more condensers are used to remove the water from the exhaust flows, with the water being directed from the condenser(s) into the water reservoir and transport system which then provides the water to one or more humidifiers for the reactant flow. One additional concern for this type of condenser/humidifier approach is that the latent heat involved in the condensing and re-evaporation of the water should be transferred from the condenser to the humidifier for most efficient operation of the system, but is subject to heat loss during the transfer, especially when an intermediate transfer media is used to transfer the condensing and re-evaporation energy.

### SUMMARY OF THE INVENTION

In accordance with one form of the invention, a cathode inlet gas humidification system is provided for a fuel cell system including a fuel cell and a compressor for supplying a cathode inlet gas flow to a cathode side of the fuel cell. The humidification system includes an exhaust flow path to direct a cathode exhaust flow from the cathode side of the fuel cell, and an inlet flow path to direct the cathode inlet gas flow from the compressor to the cathode side of the fuel cell, with a first portion of the inlet flow path located in heat exchange relation with a first portion of the exhaust flow path to transfer heat from the cathode inlet gas flow to the cathode exhaust flow. The humidification system further includes a water vapor permeable membrane located between a second portion of the exhaust flow path and a second portion of the inlet flow path to transfer water vapor from the cathode exhaust flow to the cathode inlet gas flow. The second portion of the inlet flow path is located downstream from the first portion with respect to the cathode inlet gas flow.

In one form, the first and second portions of the exhaust flow path are the same portion.

According to one form, the second portion of the exhaust flow path is located downstream from the first portion.

In one form, the water vapor permeable membrane is a perforated piece of sheet metal with water vapor permeable material filing the perforations.

According to one form, the second portions of the inlet and exhaust flow paths extend parallel to each other, and the water vapor permeable membrane has a corrugated cross-section transverse to the parallel portions of the flow paths.

In one form, the humidification system further includes respective inlets and outlets for each of the flow paths. The respective inlets and outlets are arranged to provide a counter-flow relation between the cathode inlet gas flow in the first portion of the inlet flow path and the cathode exhaust flow in the first portion of the exhaust flow path, and a counter-flow relation between the cathode inlet gas flow in the second portion of the inlet flow path and the cathode exhaust flow in the second portion of the exhaust flow path.

In accordance with one form of the invention, a heat/mass exchanger is provided for humidifying a cathode inlet gas flow to a cathode side of a fuel cell in a fuel cell system including a compressor for supplying the cathode inlet gas flow to the heat/mass exchanger. The heat/mass exchanger includes a housing, a cathode exhaust flow path in the housing to direct a cathode exhaust flow through the housing, an upstream inlet gas flow path in heat exchange relation to the cathode exhaust flow path to direct the cathode inlet gas flow from the compressor through the housing in heat exchange relation with the cathode exhaust flow in the cathode exhaust flow path, a downstream inlet gas flow path in the housing to direct the cathode inlet gas flow received from the upstream inlet gas flow path through the housing, and a water vapor permeable membrane in the housing and including a first surface defining at least part of the cathode exhaust flow path and a second surface defining at least part of the downstream inlet gas flow path to transfer water vapor from the cathode exhaust flow in the cathode exhaust flow path to the cathode inlet gas flow in the downstream inlet flow path.

In one form, the upstream and downstream inlet flow paths are located on opposite sides of the cathode exhaust flow path.

According to one form, the water vapor permeable membrane is a perforated piece of sheet metal with water vapor permeable material filing the perforations.

In one form, the downstream inlet gas flow path extends parallel to the cathode exhaust flow path, and the water vapor permeable membrane has a corrugated cross-section transverse to the parallel flow paths.

According to one form, the heat/mass exchanger further includes respective inlets and outlets for each of the flow paths. The respective inlets and outlets are arranged to provide a counter-flow relation between the cathode inlet gas flow in the upstream inlet gas flow path and the cathode exhaust flow in the cathode exhaust flow path, and a counter-flow relation between the cathode inlet gas flow in the downstream inlet gas flow path and the cathode exhaust flow in the cathode exhaust flow path.

In accordance with one form of the invention, a method of humidifying a cathode inlet gas flow is provided for a fuel cell system including a fuel cell and a compressor for supplying the cathode inlet gas flow to a cathode side of the fuel cell. The method includes the steps of:

a) transferring heat from the cathode inlet gas flow to a cathode exhaust flow at a first flow location with respect to the cathode inlet gas flow; and

b) transferring water vapor from the cathode exhaust flow to the inlet gas flow at a downstream flow location from the first flow location with respect to the cathode inlet gas flow.

In one form, steps a) and b) occur at the same flow location with respect to the cathode exhaust flow.

According to one form, step a) occurs at a cathode exhaust flow location upstream from a cathode exhaust flow location for step b) with respect to the exhaust flow.

Other objects, advantages, and features of the invention will become apparent from a complete review of the specification, including the appended claims and drawings.

### BRIEF DESCRIPTION OF THE DRAWINGS

FIG. 1 is a diagrammatic representation of a humidification system and method embodying the invention for use in a fuel cell system;

FIG. 2 is a diagrammatic representation of an alternate version of the humidification system and method of FIG. 1;

FIG. 3 is a somewhat diagrammatic cross-section of one embodiment of a heat/mass exchanger for use in the system and method of FIG. 2;

FIG. 4 is a perspective view of one embodiment of a fin portion of a water permeable membrane that can be used in the system and method of the invention;

FIG. 5 is a diagrammatic representation of a modification to the humidification system and method of FIG. 1; and

FIG. 6 is a diagrammatic representation of another modification to the humidification system and method of FIG. 1.

### DETAILED DESCRIPTION OF THE PREFERRED EMBODIMENTS

With reference to FIG. 1, a cathode inlet gas humidification method and system is 10 is shown for use in a fuel cell system 12 including a solid electrolyte membrane type fuel cell 14 and a compressor 16 for supplying a pressurized cathode inlet gas flow 18 to a cathode side 20 of the fuel cell 14. The cathode inlet gas is commonly referred to as the oxidant for the fuel cell 14 and is often provided in the form of air that has been pressurized by the compressor 16. As a result of the pressurization by the compressor 16, the cathode inlet gas flow 18 is typically at a relatively high temperature. While the humidification method and system 10 is shown in connection with the solid electrolyte membrane type fuel cell 14, it should be understood that the humidification method and system 10 may find use with any type of fuel cell that requires humidification of its cathode inlet gas flow. It should also be appreciated that the fuel cell system 12 will typically include many more components and subsystems than are illustrated herein, such as for example, a fuel processing subsystem, an anode exhaust gas combustor, and additional regenerative or recuperative heat exchanger units. However, the details of such components are known and are not critical to an understanding of the invention.

The humidification system 10 includes an exhaust flow path 22 to direct a humid cathode exhaust flow 24 from an exhaust outlet 26 of the cathode side 20 through the system 10, and an inlet flow path 25 to direct the cathode inlet gas flow 18 from the compressor 16 through the system 10 to an inlet 28 of the cathode side 20.

A heat exchanger section 30 of the system 10 includes a first portion 32 of the inlet flow path 25 located in heat exchange relation with a first portion 34 of the exhaust flow path 22 to transfer heat from the cathode inlet gas flow 18 to the exhaust flow 24. A second heat exchanger section 36 of the system 10 includes a water vapor permeable membrane 38 located between a second portion 40 of the inlet flow path 25 and a second portion 42 of the exhaust flow path 22 to transfer water vapor from the cathode exhaust flow 24 to the cathode inlet gas flow 18, thereby humidifying the cathode inlet gas flow 18 before it enters the cathode side 20 of the fuel cell 14. Inherently, the latent heat of the water vapor is also transferred to the inlet gas flow 18. Thus, the second heat exchanger section 36 acts as a heat/mass exchanger. Suitable fluid conduits, such as hoses, tubes, or fluid passages integrated into other structures of the system 10, define the flow paths 22 and 25 between the heat exchanger sections 30 and 36. The heat exchanger sections 30 and 36 can be provided as separate, distinct heat exchanger units, or the heat exchanger sections 30 and 36 can be provided as an integrated heat exchanger unit, as schematically illustrated by the dashed box 43 in FIG. 1. As seen in FIG. 1, the second portion 40 of the inlet flow path 25 is located downstream from the first portion 32 of the inlet flow path 25 with respect to the cathode inlet flow 18.

Preferably, again as seen in FIG. 1, the respective portions 32, 34 and 40, 42 of the inlet and exhaust flow paths 22, 25 have a counter-flow relation in each of the heat exchanger sections 30 and 36. In this regard respective inlets 44, 46, 48, 50 and outlets 52, 54, 56, and 58 for each of the portions 32, 34, 40, and 42 are arranged to provide the desired counter-flow relations. However, in some applications, a counter-flow relation may not be required for both heat exchanger sections 30 and 36.

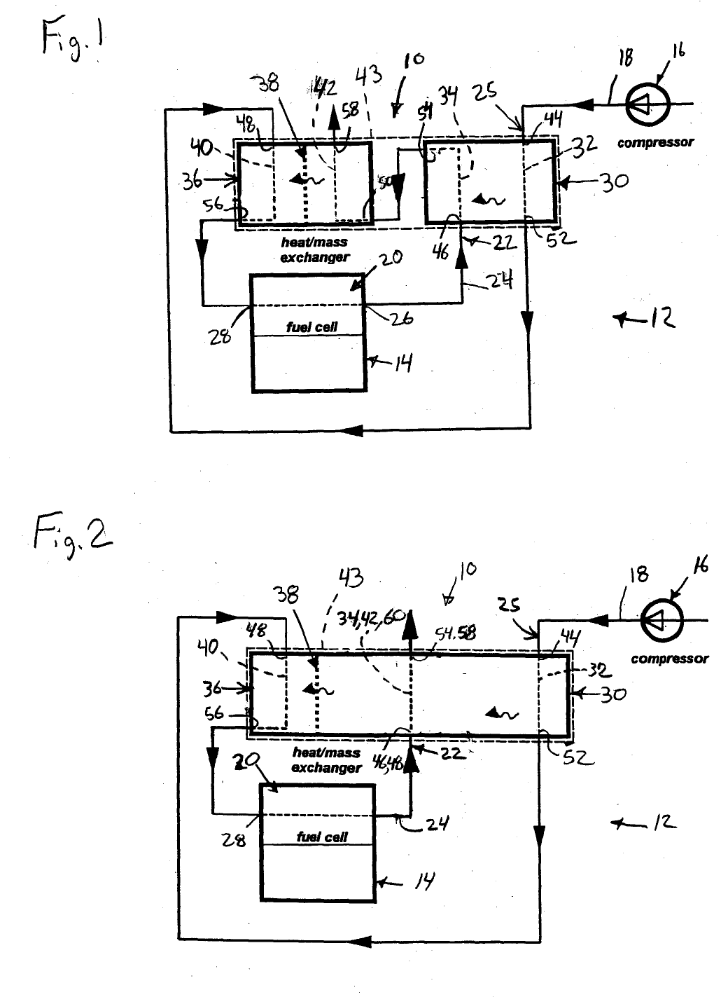

It can also be seen in FIG. 1 that the second portion 42 of the exhaust flow path 22 is located downstream from the first portion 34. However, as seen in FIG. 2, in some applications, the first and second portions 34 and 42 are at the same flow location with respect to the exhaust flow 24 and, accordingly, are the same portion 60 of the exhaust flow path 22. In this arrangement, heat is transferred from the inlet gas flow 18 in the first portion 32 of the inlet flow path 25 to the exhaust flow 24 in the portion 60 of the exhaust flow path 22 and water vapor is transferred from the exhaust flow 24 in the portion 60 to the inlet gas flow 18 in the second portion 40 of the inlet flow path 25.

In operation, for both FIGS. 1 and 2, the transfer of heat from the cathode inlet gas flow 18 in the first portion 32 of the inlet flow path 25 to the exhaust flow 24 in the portion 42, 60 increases the amount of water vapor and reduces the amount of condensed water in the exhaust flow 24 in the portion 42, 60. This increased concentration gradient of water vapor acts to increase the driving potential for the transfer of mass (water vapor) through the water permeable membrane 38. Because the amount of water vapor that is transferred to the inlet gas flow 18 is increased relative to the amount of condensed water that is transferred, less latent heat is required to evaporate the water on the inlet gas flow side of the water permeable membrane 38. It should be understood that the temperature of the inlet gas flow 18 in the second portion 40 of the inlet flow path 25 relative to the exhaust flow 24 in the portion 42, 60 may vary from system to system and from operating condition to operating condition within each system. Accordingly, in some systems, or under some operating conditions, sensible heat may be transferred from the inlet gas flow 18 in the portion 40 to the exhaust flow 24 in the portion 42, 60, while in other systems, or under other operating conditions, sensible heat may be transferred from the exhaust flow 24 in the portion 42, 60 to the inlet gas flow 18 in the portion 40. However, in all systems and ideally under all operating conditions for the systems, latent heat will be transferred inherently with the transfer of the water vapor from the cathode exhaust flow 24 in the portion 42, 60 to the inlet gas flow 18 in the second portion 40.

Another important aspect of the system 10 is that the first heat exchanger section 30 have a sufficient efficiency to cool the inlet gas stream down to a suitable inlet temperature for the cathode side 20 of the fuel cell 14 by the transfer of heat from the inlet gas flow 18 in the portion 32 to the exhaust flow 24 in the portion 34. For example, in some typical fuel cell systems, the inlet gas flow 18 will be air that has been compressed to around three bars with a temperature around 210° C., which according to an analysis by the inventor, will require a heat exchanger efficiency of at least 0.85 to cool the compressed air down to a suitable temperature of around 90° C. by transferring heat to the cathode exhaust flow 24. If such efficiency can't be achieved, an additional heat exchanger may be provided to reduce the temperature of the inlet gas flow 18.

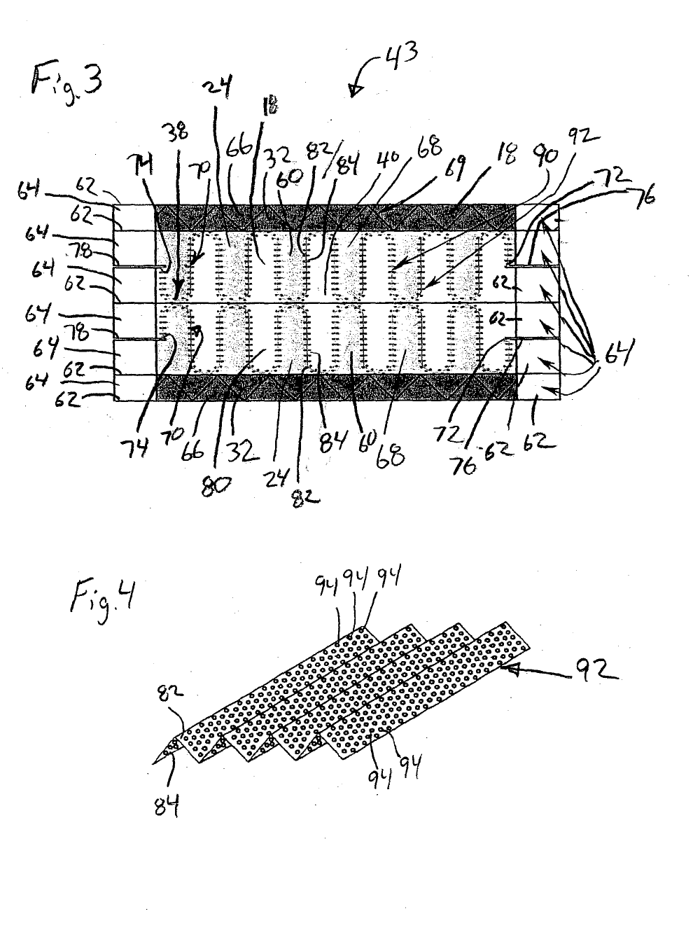

FIG. 3 illustrates a transverse cross-section of one possible embodiment for an integrated heat exchanger unit 43 incorporating the portion 60 of FIG. 2. The heat exchanger unit 43 of FIG. 3 is a bar-plate type construction, with elongate, planar plates 62 and spacer bars 64 extending in and out of the page to enclose a pair of outermost fluid channels 66 that extend longitudinally in and out of the page and define the first portion 32 of the inlet flow path 25, and a pair of sandwiched fluid channels 68 that extend longitudinally in and out of the page and define the portion 60 of the exhaust flow path 22. While not required in all applications, a suitable heat exchange fin or turbulator 69 can be provided in each of the fluid channels 66 to enhance the transfer of heat from the cathode inlet gas flow 18. The water permeable membrane 38 is provided in the form of two corrugated pieces 70 having opposite edges 72 and 74 sealingly bonded to respective side plates 76 and 78. Preferably, as shown in FIG. 3, the pieces 70 are corrugated transverse to the flow directions of the inlet and exhaust flows 18 and 24, which are flowing parallel to each other in and out of the page. The pieces 70 enclose an inner fluid channel 80 that extends longitudinally in and out of the page and is sandwiched between the fluid channels 68. The fluid channel 80 defines the second portion 40 of the inlet gas flow path 25. More specifically, one side or surface 82 of each of the pieces 70 of the water permeable membrane 38 defines part of the portion 60 of the exhaust flow path 22 and an opposite side or surface 84 of each of the pieces 70 of the water permeable membrane 38 defines the second portion 40 of the cathode inlet gas flow path 25.

Preferably, the water vapor permeable membrane 38 is made from a material possessing superior water vapor mass-transfer properties with the membrane permanence for water vapor being dominant over the membrane permanence for liquid water, and with good selectivity of water vapor over oxygen. The above parameters for the water vapor permeable membrane 38 are desirable because the total pressure of the inlet gas flow 18 in the portion 40 is higher than the total pressure of the cathode exhaust flow 24 in the portion 42, 60, which results in the total pressure gradient through the membrane 38 being opposite to the direction that the water vapor needs to be transferred. In view of this, the total pressure driven viscous flow has to be minimized through the membrane 38, while the concentration gradient driven diffusion flow needs to be dominate because the concentration (partial pressure) gradient of water vapor is higher on the cathode exhaust flow side of the membrane 38. Similarly, the membrane 38 should be far less permeable to oxygen than water vapor because the oxygen partial pressure is higher on the inlet gas flow side of the membrane 38 than on the exhaust flow side and passage of oxygen from the inlet gas flow 18 to the exhaust flow 24 would reduce the amount of oxygen supplied to the cathode side of the fuel cell and result in degradation of fuel cell performance. In this regard, the selectivity of water vapor over oxygen for the membrane 38 can be optimized depending upon how much the fuel cell performance is effected by diluting the oxygen concentration in the inlet gas flow 18 versus increasing the humidity of the inlet gas flow 18. Ideally, the size of the system 10 is a concern, the permanence for water vapor of the membrane 38 should be as high as possible, so as to minimize the size of the membrane 38 required to transport the desired amount of water vapor. For example, based on an analysis by the inventor for automobile type applications, the membrane permanence for water vapor should be at least 0.4 cm/s for a reasonable size of the heat exchanger section 36 for the system 10. If the material of the membrane 38 is a flexible sheet 90, the permeable membrane 38 may also include a perforated sheet metal fin, as shown schematically at 92 in FIG. 3 and in perspective in FIG. 4, that provides structural support for flexible sheet 90. While the fin 92 is shown as having a corrugated cross-section transverse to the flow direction of the exhaust and inlet gas flows, it may be desirable in some applications for the fin 92 to have some other shape, such as for example, a planar shape similar to the plates 62. The perforations 94 in the fin 92 can be in the form of small slots, slits, louvers, or circular holes.

Another possible alternative for the permeable membrane 38 is to fill the perforation 94 of the fin 92 with a suitable water vapor permeable material, rather than to use a flexible sheet 90 supported by the fin 92. This type of construction can be provided by applying a wet mixture of generally spherical particles of sufficiently small size to be classified as a powder, a braze alloy powder, and a liquid binder to one or both of the surfaces 82, 84 of the fin 92 and then heat-treating the fin 92 to mechanically fuse the spherical particle powder in the perforations 94. In this regard, the perforations 94 should be sized in accordance with the point at which the adhesive forces of the wet mixture and the substrate overcome the cohesive forces of the wet mixture, thereby permitting the wet mixture to adhere to the edges of the perforations 94 and form a “bridging” meniscus film via capillary attraction. This allows a number of water vapor permeable films to be formed in the fin 92 equal to the number of perforations 94 in the fin 92. The wet mixture can be applied to the fin 92 by any suitable means, such as for example, spraying, rolling, or dipping. It may be desirable to remove the wet mixture from the surfaces 82, 84 of the fin 92, via a towel or wipe, after the wet mixture has filled the perforations 94 to allow for a controlled volume of the wet mixture to be used, and to minimize outward obtrusions on the surfaces 82 and 84 that might otherwise form if excess wet material is left on the surfaces 82 and 84 during heat-treating. This allows for the surface area of the fin 92 to be quantified after heat-treating and minimizes pressure drop in the fluid flows passing over the fin 92. A detailed discussion of some preferred formulations, application procedures, and heat treating for such a wet mixture is provided in commonly assigned U.S. application Ser. No. 10/140,349, filed on May 7, 2002, titled “Evaporative Hydrophilic Surface For A Heat Exchanger, Method Of Making The Same And Composition Therefor,” naming Alan P. Meissner and Richard Park Hill as inventors, the entire disclosure of which is incorporated herein by reference.

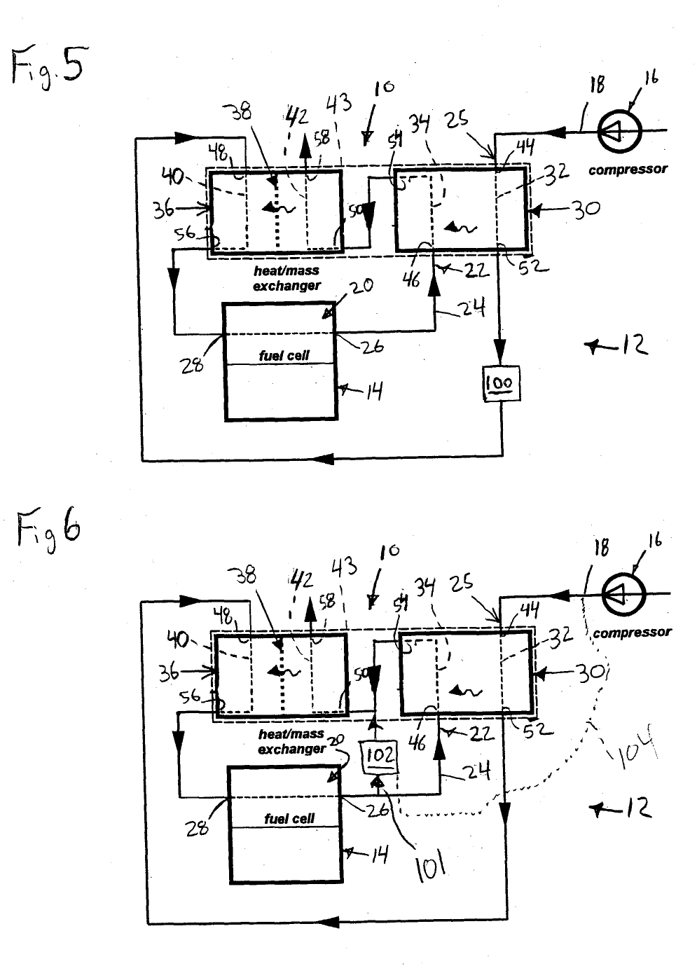

FIG. 5 illustrates a modification to the system 10 of FIG. 1 wherein a suitable back pressure regulator valve 100 has been added downstream from the outlet 52 and upstream of the inlet 48. For some applications, such as for example where the system operating pressure is low (atmospheric fuel cell systems, or during low-power settings for transportation systems) and/or during cold ambient temperature conditions, the back pressure regulator valve 100 could be used to increase the output pressure of the compressor 16, thereby generating an additional heat and a higher temperature in the inlet gas flow 18 which then can be transferred to the exhaust flow 24 passing through the first portion 34 of the exhaust flow path 22. This would help to vaporize any liquid water carried in the exhaust flow 24, and increase the partial pressure gradient in the heat/mass exchanger section 36. It should be understood that the particular back pressure regulator valve 100 selected will be highly depended upon the specific parameters of each application and that there are many suitable and known back pressure regulator valves 100 that could be used in the system 10.

FIG. 6 shows another modification to the system 10 of FIG. 1 wherein a by-pass flow path 101 has been inserted into the exhaust flow path 22, extending from the outlet 26 to the inlet 50 to by-pass the first portion 34 of the exhaust flow path 22. The by-pass flow path 101 includes a suitable by-pass valve 102 that could be selectively opened from a normally closed position under conditions where the temperature of the inlet gas flow 18 exiting the compressor and/or entering the first portion 32 is lower than the temperature of the exhaust flow 24 in the first portion 34 of the exhaust flow path 22, such as for example, during low-power settings for transportation systems where the system operating pressure is low, or during cold ambient temperature conditions. In this regard, the by-pass valve 102 could be actively controlled by a suitable control scheme that includes a temperature sensor that senses the temperature of the inlet gas flow 18 exiting the compressor 16 and/or entering the first portion 32 of the inlet flow path 25, as shown diagrammatically at 104. The by-passing of the exhaust flow 24 around the first portion 34 of the exhaust flow path 22 during the above described conditions prevents the exhaust flow 24 from being cooled by the inlet gas flow 18 in the first heat exchanger section 30 which could result in the condensation of water rather than the desired vaporization of water in the exhaust flow 24. It should be understood that the particular type and details of the by-pass valve 102 and the control scheme will be highly dependent upon the parameters and requirements of each particular system 10, and that there are many known and suitable by-pass valves 102 and control schemes therefor.

It should be appreciated that while specific embodiments for the heat exchanger unit 43 and permeable membrane 38 have been described above, the details and construction of the heat exchange unit, the heat exchange sections 30 and 36, and the membrane 38 will be highly dependent upon the particular parameters of each application, such as for example, the flow rates, temperatures and pressures of the inlet gas and exhaust flows 18 and 24, the amount of humidification required for the inlet gas flow 18 entering the cathode side 20, and the humidity of the exhaust flow 18 exiting the cathode side 20. In this regard, any suitable heat exchanger construction can be used for the heat exchanger unit 43, and/or the heat exchanger sections 30 and 36. Furthermore, it should be appreciated that some fuel cell systems 12 may utilize other components through which the inlet gas flow 18 and/or exhaust flow 24 pass on their way to and from the cathode side 20, such as for example, additional heat exchangers to transfer heat to or from the inlet gas flow 18 and/or the exhaust flow 24 between the respective sections 32, 40 and 34, 42 and/or between the sections 34 and 40 and the cathode side 20.

What is claimed is:

1. A cathode inlet gas humidification system for a fuel cell system including a fuel cell and a compressor for supplying a cathode inlet gas flow to a cathode side of the fuel cell, the humidification system comprising:
an exhaust flow path to direct a cathode exhaust flow from the cathode side of the fuel cell, an inlet flow path to direct the cathode inlet gas flow from the compressor to the cathode side of the fuel cell, a first portion of the inlet flow path located in heat exchange relation with a first portion of the exhaust flow path to transfer heat from the cathode inlet gas flow to the cathode exhaust flow; and
a water vapor permeable membrane located between a second portion of the exhaust flow path and a second portion of the inlet flow path to transfer water vapor from the cathode exhaust flow to the cathode inlet gas flow, the second portion of the inlet flow path located downstream from the first portion with respect to the cathode inlet gas flow.

2. The humidification system of claim 1 wherein the first and second portions of the exhaust flow path are the same portion.

3. The humidification system of claim 1 wherein the second portion of the exhaust flow path is located downstream from the first portion.

4. The humidification system of claim 1 wherein the water vapor permeable membrane comprises a perforated piece of sheet metal with water vapor permeable material filing the perforations.

5. The humidification system of claim 1 wherein the water vapor permeable membrane comprises a perforated piece of sheet metal and a flexible water vapor permeable sheet supported by the perforated piece of sheet metal.

6. The humidification system of claim 1 wherein the second portions of the inlet and exhaust flow paths extend parallel to each other and the water permeable membrane has a corrugated cross-section transverse to the parallel portions of the flow paths.

7. The humidification system of claim 1 further comprising respective inlets and outlets for each of the portions the flow paths, the respective inlets and outlets arranged to provide a counter-flow relation between the cathode inlet gas flow in the first portion of the inlet flow path and the cathode exhaust flow in the first portion of the exhaust flow path.

8. The humidification system of claim 1 further comprising respective inlets and outlets for each of the flow paths, the respective inlets and outlets arranged to provide a counter-flow relation between the cathode inlet gas flow in the second portion of the inlet flow path and the cathode exhaust flow in the second portion of the exhaust flow path.

9. The humidification system of claim 1 further comprising respective inlets and outlets for each of the flow paths, the respective inlets and outlets arranged to provide a counter-flow relation between the cathode inlet gas flow in the first portion of the inlet flow path and the cathode exhaust flow in the first portion of the exhaust flow path, and a counter-flow relation between the cathode inlet gas flow in the second portion of the inlet flow path and the cathode exhaust flow in the second portion of the exhaust flow path.

10. The humidification system of claim 1 further comprising a pressure regulator valve located in the inlet flow path downstream of the first portion of the inlet flow path and upstream from the cathode side of the fuel cell with respect to the cathode inlet gas flow.

11. The humidification system of claim 1 further comprising a by-pass flow path located downstream from the cathode side of the fuel cell and upstream from the second portion of the exhaust flow path with respect to the cathode exhaust flow to selectively by-pass cathode exhaust flow around the first portion of the exhaust flow path.

12. A heat/mass exchanger for humidification of a cathode inlet gas flow to a cathode side of a fuel cell of a fuel cell system including a compressor for supplying the cathode inlet gas flow to the heat/mass exchanger, the heat/mass exchanger comprising:
a housing;
a cathode exhaust flow path in the housing to direct a cathode exhaust flow through the housing;
an upstream inlet gas flow path in heat exchange relation to the cathode exhaust flow path to direct the cathode inlet gas flow from the compressor through the housing in heat exchange relation with the cathode exhaust flow in the cathode exhaust flow path;
a downstream inlet gas flow path in the housing to direct the cathode inlet gas flow received from the upstream inlet gas flow path through the housing; and
a water vapor permeable membrane in the housing and including a first surface defining at least part of the cathode exhaust flow path and a second surface defining at least part of the downstream inlet gas flow path to transfer water vapor from the cathode exhaust flow in the cathode exhaust flow path to the cathode inlet gas flow in the downstream inlet flow path.

13. The heat/mass exchanger of claim 12 wherein the upstream and downstream inlet flow paths are located on opposite sides of the cathode exhaust flow path.

14. The heat/mass exchanger of claim 12 wherein the water vapor permeable membrane is a perforated piece of sheet metal with water vapor permeable material filing the perforations.

15. The heat/mass exchanger of claim 12 wherein the downstream inlet gas flow path extends parallel to the cathode exhaust flow path, and the water vapor permeable membrane has a corrugated cross-section transverse to the parallel flow paths.

16. The heat/mass exchanger of claim 12 further comprising respective inlets and outlets for each of the flow paths, the respective inlets and outlets arranged to provide a counter-flow relation between the cathode inlet gas flow in the upstream inlet gas flow path and the cathode exhaust flow in the cathode exhaust flow path.

17. The heat/mass exchanger of claim 12 further comprising respective inlets and outlets for each of the flow paths, the respective inlets and outlets arranged to provide a counter-flow relation between the cathode inlet gas flow in the downstream inlet gas flow path and the cathode exhaust flow in the cathode exhaust flow path.

18. The heat/mass exchanger of claim 12 further comprising respective inlets and outlets for each of the flow paths, the respective inlets and outlets arranged to provide a counter-flow relation between the cathode inlet gas flow in the upstream inlet gas flow path and the cathode exhaust flow in the cathode exhaust flow path, and a counter-flow relation between the cathode inlet gas flow in the downstream inlet gas flow path and the cathode exhaust flow in the cathode exhaust flow path.

19. The heat/mass exchanger of claim 12 wherein the water permeable membrane comprises a perforated piece of sheet metal and a flexible water permeable sheet supported by the perforated piece of sheet metal.

20. A method of humidifying a cathode inlet gas flow for a fuel cell system including a fuel cell and a compressor for supplying the cathode inlet gas flow to a cathode side of the fuel cell, the method comprising the steps of:
a) transferring heat from the cathode inlet gas flow to a cathode exhaust flow at a first flow location with respect to the cathode inlet gas flow; and
b) transferring water vapor from the cathode exhaust flow to the inlet gas flow at a downstream flow location from the first flow location with respect to the cathode inlet gas flow.

21. The method of claim 20 wherein steps a) and b) occur at the same flow location with respect to the exhaust gas flow.

22. The method of claim 20 wherein step a) occurs at a cathode exhaust flow location upstream from a cathode exhaust flow location for step b) with respect to the exhaust gas flow.
